(19) United States
(12) Patent Application Publication
(10) Pub. No.: US 2023/0084898 A1
(43) Pub. Date: Mar. 16, 2023

(54) FILLING APPARATUS FOR A ROTARY PRESS AND A SYSTEM FOR CONTINUOUSLY PROCESSING PULVERULENT PRODUCTS

(71) Applicant: Fette Compacting GmbH, Schwarzenbek (DE)

(72) Inventors: Jan Naeve, Kehrsen (DE); Stefan Lüdemann, Hamburg (DE); Sven Kolbe, Büchen (DE); Frank Schade, Tramm (DE)

(73) Assignee: Fette Compacting GmbH, Schwarzenbek (DE)

(21) Appl. No.: 17/939,124

(22) Filed: Sep. 7, 2022

(30) Foreign Application Priority Data
Sep. 9, 2021 (DE) 10 2021 123 339.9

(51) Int. Cl. B30B 15/30; B30B 11/08

(52) U.S. Cl. CPC B30B 15/304; B30B 11/08; B30B 15/308

(57) ABSTRACT

A filling apparatus for filling cavities of a rotary press includes a filling chamber defining an inlet opening through which filling material enters the filling chamber and an outlet opening through which filling material exits into the cavities of the rotary press. A conveyor wheel is positioned in the filling chamber and defines a plurality of conveyor pockets structured to receive the filing material. The conveyor wheel is rotatable relative to the filling chamber about an axis of rotation arranged at an angle (α) to a vertical axis. The plurality of conveyor pockets are arranged along a circular path and are rotated along the inlet opening and along the outlet opening when the conveyor wheel is rotated about the axis of rotation. The filling material received in each of the plurality of the plurality of conveyor pockets is conveyed from the inlet opening to the outlet opening.

### CROSS REFERENCE TO RELATED INVENTION

This application is based upon and claims priority to, under relevant sections of 35 U.S.C. § 119, German Patent Application No. 10 2021 123 339.9, filed Sep. 9, 2021, the entire contents of which are hereby incorporated by reference.

### TECHNOLOGICAL FIELD

This disclosure is directed to a filling apparatus for filling cavities of a rotary press, comprising a filling chamber with an inlet opening through which filling material enters the filling chamber, and an outlet opening through which filling material exits into the cavities of the rotary press. The disclosure is further directed to a rotary press and to a system for continuously processing pulverulent products.

### BACKGROUND

In rotary presses, pulverulent filling material is typically pressed in cavities of the die plate by upper and lower punches to form pellets, for example tablets. The filling material is supplied to the cavities by means of a filling apparatus. Different types of filling apparatuses are known, for example three-chamber filling devices, feed shoes, or multilevel filling systems. Filling apparatuses that achieve a particularly high volume throughput and thus a high production output of the rotary press are widely used. Particularly economical production is hereby achieved. Filling apparatuses are known, for example, from EP 2 065 174 B1 or DE 10 2016 110 556 B4.

The structure of common filling apparatuses is generally similar. The filling apparatus usually has a filling chamber which is filled with the filling material, for example, by means of gravity. A powder column in a supply tube stands vertically on the filling chamber. One or more stirrer blade wheels with stirrer blades or the like are arranged in the filling chamber. By rotating the stirrer blade wheels, the filling material is distributed in the filling chamber and material buildup or bridging should be prevented. The filling material then enters into the cavities through an outlet opening in the filling chamber. This also occurs due to gravity. The filling material is processed in the cavities to form pellets.

A filling apparatus is also known from JP 2018 192517 A with a passage part for filling material, the base of which is tilted in the direction of an outlet. This is intended to further improve the transport of powder due to gravity. In the passage part, a rotating mixer blade is arranged, which stirs the pulverulent filling material in order to improve the powder flow.

The filling apparatuses explained above show good results in particular from the perspective of the tableting output of tablet presses. However, with the increasing prevalence of continuous production methods in tablet production, the tableting output alone is no longer in the foreground. Instead, the entire added value process from the initial products to the batch release should be considered and evaluated. Particularly, a real-time release of product batches requires that the location of individual product packages within the product flow can be determined and predicted at any time, in order to be able to eject packages that do not correspond to the specification. In this case, filling apparatuses of rotary presses play a particular role. In the known filling apparatuses, the filling material has a high residence time in the filling chamber. Due to the stirring of the filling material by means of stirrer blade wheels or mixer blades, a typically circular, horizontal distribution of the filling material in the filling chamber takes place. This mixing of the filling material in the filling chamber in combination with the long residence time leads to an assignment of product packages to specific locations or times not being reliably possible. In addition to the residence time of the filling material in the filling chamber, this also applies to the sequence of the exit from the filling apparatus.

The stirrer blades or mixer blades can also cause an undesired precompression of the filling material in the filling apparatus, and the structure of the pulverulent filling material can be negatively influenced, for example ground up. At the same time, a sufficient throughput volume should be achieved so that the filling apparatus can be considered for mass production.

Starting from the explained prior art, the object of the invention is therefore to provide a filling apparatus as well as a rotary press and a system of the type mentioned above with which the aforementioned disadvantages can be avoided. In particular, it should be possible to be able to better track the progress of product packages in the filling apparatus, while at the same time being suitable for mass production and the properties of the filling material being influenced as little as possible.

The invention achieves the object by the subject matter of independent claim 1. Advantageous embodiments are disclosed in the dependent claims, the description and the figures.

### BRIEF SUMMARY OF THE INVENTION

For a filling apparatus of the type mentioned above, the invention achieves the object in that a conveyor wheel rotatable by means of a rotary drive about an axis of rotation arranged at an angle to the vertical is arranged in the filling chamber, with a plurality of conveyor pockets arranged along a circular path for receiving filling material, wherein the conveyor pockets rotate along the inlet opening and along the outlet opening when the conveyor wheel is rotated about its axis of rotation, so that filling material received in the conveyor pockets is conveyed from the inlet opening to the outlet opening.

As already explained, the filling apparatus serves to fill cavities of a rotary press, in particular a rotary tablet press. The cavities can be designed in a die plate of a rotor of a rotary press. The filling apparatus comprises a filling chamber with an inlet opening, through which filling material enters the filling chamber. The filling material can be a powder. It can also be a material mixture composed of multiple components, for example at least one active pharmaceutical ingredient (API) and at least one excipient. The filling apparatus can comprise a filling tube, the outlet of which is connected to the inlet opening of the filling chamber, and through which filling material enters the inlet opening due to gravity. The filling material can flow into the filling chamber through the inlet opening due to gravity. The filling chamber has an outlet opening, through which the filling material flows into the cavities of the rotary press.

In an embodiment, a conveyor wheel rotatable by means of a rotary drive about an axis of rotation arranged at an angle to the vertical is arranged in the filling chamber. The conveyor wheel has a plurality of conveyor pockets arranged along a circular path for receiving filling material. When the conveyor wheel rotates about its axis of rotation, the conveyor pockets rotate along the inlet opening and along the outlet opening, so that filling material received in the conveyor pockets is conveyed by the conveyor wheel from the inlet opening to the outlet opening. The axis of rotation of the conveyor wheel is arranged in particular tilted from the vertical, meaning in an angular range of less than 90° and greater than 0°. The angle of the axis of rotation compared to the vertical can be, for example, in the range from 30° to 60°. By arranging the conveyor wheel non-horizontally, an inclined position of the conveyor wheel along the inlet opening—outlet opening line is achieved. The conveyor pockets, into which the filling material enters through the inlet opening, for example due to gravity, are designed in a radially outer region of the conveyor wheel. The conveyor pockets each receive an amount of filling material defined by its volume and convey it, in the course of the rotation of the conveyor wheel, along a circular path from the inlet opening to the outlet opening, from where the filling material enters the cavities. The upper side of the filling chamber can be closed by a cover. The conveyor wheel rotates over a base of the filling chamber. For example, a filling tube for supplying the filling material to the inlet opening can be guided through such a cover. The rotary drive for the conveyor wheel can be, for example, an electric motor.

According to an embodiment, the filling material stream entering into the inlet opening is divided into volume packets corresponding to the volume of the conveyor pockets, which are then transported, in particular actively and in a defined manner, by the conveyor pockets to the outlet opening. Through the active conveying according to the invention of the filling material from the inlet opening to the outlet opening by means of the conveyor pockets, the filling material is transported on a short and direct path from the inlet opening to the outlet opening. Accordingly, a short residence time of the filling material within the filling chamber is achieved. The amount of filling material filled into the cavities can be directly controlled by the conveyor wheel and thus monitored. This also applies to the filling pressure with which the filling material is conveyed into the cavities. By transporting the filling material in a targeted manner, lower forces are exerted on the powder. In particular, in contrast to the prior art explained above, no mixer blade or the like is required to loosen and distribute filling material. The disadvantages associated therewith are avoided. Through the monitored active conveying of the filling material, in particular of the volume packages defined by the conveyor pockets, from the inlet opening to the outlet opening with the conveyor wheel, a first-in-first-out principle for the transport of the filling material through the filling chamber can be realized. This in combination with the short residence time enables the progress of the filling material in the filling apparatus, in particular of individual product packages, comprising one or more of the volume packages, to be tracked reliably. As a result, the filling apparatus in turn does not stand in the way of assigning pellets produced in the rotary press to specific filling material packages. In the invention, the filling amount which passes through the outlet opening, is not necessarily determined by gravity alone. Instead, the active filling material transport provides a control possibility. A circular, horizontal distribution of filling material in the filling chamber, as in the prior art, is avoided. This also prevents the danger of powder buildup (dead spaces). The forces actively exerted on the filling material act in the direction of the outlet opening and therefore do not lead to a negative influence on the structure of the filling material. In order to reduce the size of the volume packages conveyed by the conveyor pockets to a degree that is easily conveyable, a plurality of conveyor pockets is provided. The conveyor wheel can have, for example, at least six conveyor pockets, further preferably at least eight conveyor pockets, in particular more than eight conveyor pockets.

As already explained, the conveyor wheel rotates above the base of the filling chamber. The shape of the base of the filling chamber can be adapted to the shape of the underside of the conveyor wheel. The adaptation can be such, for example, that a distance that remains basically the same exists between the underside of the conveyor wheel and the base of the filling chamber over the entire surface extent. Since a (small) gap between the base of the filling chamber and the underside of the conveyor wheel must necessarily be present to prevent undesired contact of the rotating conveyor wheel with the base of the filling chamber, a (small) amount of filling material can flow directly from the inlet opening to the outlet opening lying at a lower height in certain circumstances without being received in conveyor pockets. This proportion of filling material not conveyed by the conveyor pockets, however, is very small in comparison with the proportion conveyed by the conveyor pockets. For example, more than 90%, preferably more than 95% of the conveyed material, can be conveyed by the conveyor pockets. The traceability of the product in the filling chamber is therefore still reliably given. This also applies in light of the particularly short residence time according to the invention within the filling chamber. Thus, a difference in residence time between filling material conveyed from the inlet opening to the outlet opening by the conveyor pockets and filling material possibly flowing on a direct path from the inlet opening to the outlet opening is very small. In the prior art, the residence time of filling material in filling chambers is regularly in the range of, for example, 1 minute. According to the invention, the residence time of the filling material in the filling chamber can be, however, in the range of a few seconds, for example less than 5 seconds, preferably less than 3 seconds.

According to an embodiment, the conveyor pockets can be arranged on the perimeter of the conveyor wheel. This achieves a particularly high acceleration of the conveyor pockets and thus of the filling material. As a result, a particularly effective active conveying of the filling material to the outlet opening takes place.

According to another particularly practical embodiment, the conveyor pockets can rotate under the inlet opening and over the outlet opening when the conveyor wheel is rotated about its axis of rotation. This achieves a particularly simple supply and discharge of filling material, at least supported by gravity.

According to another embodiment, the inlet opening can be arranged at a highest position of the conveyor wheel and the outlet opening can be arranged at a lowest position of the conveyor wheel. This ensures that the filling material is conveyed uniformly without forming product buildup or the like. Corresponding dead spaces are prevented.

In an embodiment, the conveyor wheel can have a plurality of lateral walls, wherein adjacent walls each delimit a conveyor pocket between them. The walls can be aligned, for example, in the radial direction in relation to the axis of rotation of the conveyor wheel. The walls can be in planes parallel to the axis of rotation.

According to another embodiment, the upper side of the filling chamber can have a cover, in particular be closed by a cover, and a distance or respectively gap between the conveyor wheel and the cover can be less than 5 mm, preferably less than 2 mm, further preferably at most 1 mm. A distance or respectively gap between the conveyor wheel and a base of the filling chamber can also be less than 5 mm, preferably less than 2 mm, further preferably less than 1 mm, for example less than 0.5 mm. With such narrow distances between the conveyor wheel and the cover or respectively the base of the filling chamber, a particularly large proportion of filling material is taken from the inlet opening to the outlet opening by the conveyor pockets in the context of active conveying. A proportion of the filling material possibly reaching the outlet opening independently of the conveying by the conveyor pockets is minimized. The traceability of the filling material conveying is further improved. The shape of the cover and/or of the base of the filling chamber can be adapted such that the respective distance or respectively gap between the conveyor wheel and the cover or respectively the base remains the same to the greatest possible extent. If the distance changes, the information above relates to a maximum distance between the conveyor wheel and the cover or respectively the base.

According to another embodiment, the conveyor pockets can each be open on their upper side and their lower side. As a result, a reliable filling and emptying of the conveyor pockets in the course of the rotation takes place.

According to another embodiment, the base of the filling chamber can be tilted in relation to a plane perpendicular to the axis of rotation at least in the region swept over by the conveyor pockets. In particular, the base can be tilted in the direction of the outlet opening. The angle in relation to the plane perpendicular to the axis of rotation can be, for example, in the range of 10° to 60°, preferably 20° to 40°. The faces below the conveyor pockets within the filling chamber are thus tilted with an angle falling in the direction of the outlet opening. The filling material therefore strives to flow in the direction of the outlet opening. This prevents dead spaces and filling material buildup even more reliably. The first-in-first-out principle can be implemented even more consistently.

In an embodiment, the base of the filling chamber can be configured conically or cone-shaped at least in the region swept over by the conveyor pockets, wherein the cone face tapers downwards in the direction of the axis of rotation. The base of the filling chamber can have in particular a concave shape or trough-shaped configuration. Furthermore, the base of the filling chamber can be configured perpendicular to the axis of rotation in a central region. The base can thus be configured, for example, in the shape of a truncated cone.

In an embodiment, the conveyor wheel can also be configured to convey filling material located in the conveyor pockets into the outlet opening through centrifugal force in the course of its rotation about the axis of rotation. On the one hand, this can be achieved by the aforementioned constructional design and, on the other hand, by a sufficient rotational speed of the conveyor wheel. The centrifugal force acts in this case in the direction of the outlet opening. An active conveying toward the outlet opening thus takes place, even independently of the effect of gravity. This achieves an even more defined conveying of the filling material than with solely a gravity emptying. By suitably setting the centrifugal force, the filling amount or the filling pressure, for example, when filling the cavities can be set in a desired manner. The generated centrifugal force here is in particular independent from other machine parameters of the rotary press, for example the rotor rotational speed. Instead, it can be controlled in a simple manner by suitably setting the rotational speed of the conveyor wheel.

In the filling apparatus according to the invention, the conveyed path of the filling material from the inlet opening to the outlet opening can be such that each redirection of the flow direction of the filling material is smaller than 90°. Any redirection angles of the filling material being smaller than 90° achieves a particularly gentle redirection and thus a particularly gentle transport of the filling material through the filling apparatus. Negative influences on the filling material are prevented with particular reliability.

According to another embodiment, a control apparatus can be provided which is configured\ to control the amount of filling material supplied to the cavities and/or the filling pressure when filling the cavities with filling material by controlling the rotary drive, in particular by setting the rotational speed of the rotary drive and thus of the conveyor wheel. The filling amount and the filling pressure can thus be set in a desire manner precisely and independently from other machine parameters, for example the rotor rotational speed of the rotary press.

The invention also achieves the object by a rotary press comprising a rotor rotatable by means of a rotary rotor drive, wherein the rotor has an upper punch guide for upper pressing punches of the rotary press and a lower punch guide for lower pressing punches of the rotary press as well as a die plate arranged between the punch guides, wherein the pressing punches interact with cavities of the die plate, further comprising a filling apparatus according to the invention by which the filling material to be pressed is filled into the cavities of the die plate, further comprising at least one upper pressing apparatus and at least one lower pressing apparatus which interact during operation with the upper pressing punches and with the lower pressing punches to press the filling material in the cavities of the die plate to form pellets, and comprising an ejector apparatus in which the pellets generated in the cavities are ejected from the rotary press.

The cavities defined in the die plate can be formed, for example, by bores in the die plate or by die sleeves placed into the die plate. The die plate can be designed annularly in one piece or be composed of multiple ring segments. The filling material filled into the cavities by the filling apparatus according to the invention is then pressed by upper and lower pressing punches associated with the cavities by interacting with an upper and lower pressing apparatus to form pellets, in particular tablets. Then the pellets are conveyed through axial displacement of the lower pressing punches upwards onto the upper side of the die plate, from where they are supplied, for example, by a stripping apparatus to the ejector apparatus that leads to an outlet of the rotary press.

The invention also achieves the object by a system for continuously processing pulverulent products, comprising at least two system inlets for pulverulent products, a mixer for continuously mixing the pulverulent products, wherein the mixer has at least one mixer inlet connected to the at least two system inlets, and wherein the mixer has a mixer outlet for filling material mixed from the pulverulent products, further comprising a rotary press according to the invention for continuously processing the filling material to form pellets, wherein the rotary press has a press inlet connected to the mixer outlet and a press outlet for pellets generated in the rotary press.

In an embodiment, the system serves to continuously process in particular pulverulent products, in particular dry pulverulent products. As already explained, these can be, for example, pharmaceutical products. The pulverulent products can thus comprise, for example, at least one active pharmaceutical ingredient (API) and at least one excipient. The pulverulent products are supplied to the system through at least two, for example more than two, system inlets. The system inlets can each comprise a metering device with which the supply of the products is metered. The pulverulent products supplied through the system inlets are supplied continuously to the at least one mixer inlet via connecting lines. From the supplied pulverulent products, the mixer continuously generates a product mixture, namely a filling material, for further processing in the rotary press. The product mixture, meaning the filling material, is provided at the mixer outlet and continuously supplied to the press inlet of the rotary press, for example, by a conveying apparatus. It should be noted that the continuous supply refers in particular to continuous processing in contrast to a batch process, which is known per se. The continuous supply also comprises in particular an intermittent supply, for example, as takes place by means of pneumatic conveyor apparatuses. The pellets, in particular tablets, produced by the rotary press from the filling material are provided at the press outlet of the rotary press. Further processing can then take place, for example, dedusting and/or packaging.

The system is a continuously working system, which, unlike a system working in accordance with the batch principle, continuously mixes the supplied pulverulent products and processes them into pellets, in particular tablets. The system can be contained, for example, with a containment level OEB 3 or higher, measured, for example, according to the SMEPAC test (Standardized Measurement for Equipment Particulate Airborne Concentrations).

### BRIEF DESCRIPTION OF THE DRAWINGS

An exemplary embodiment of the invention is explained in greater detail below based on figures. Schematically:

FIG. 1 illustrates a perspective view of an embodiment of a system for continuously processing pulverulent products;

FIG. 2 illustrates a close-up view of a portion of a rotary press of the system shown in FIG. 1 illustrating an unrolled representation of the rotor;

FIG. 3 illustrates a perspective view of an embodiment of a filling apparatus;

FIG. 4 illustrates the embodiment of FIG. 3 with the cover of the filling chamber removed;

FIG. 5 illustrates a sectional view of the embodiment of FIG. 3;

FIG. 6 illustrates a bottom perspective view of the embodiment from FIG. 3; and

FIG. 7 illustrates a perspective view of the filling chamber of the filling apparatus from the embodiment of FIG. 3 with the conveyor wheel removed.

The same reference signs refer to the same objects in the figures unless indicated otherwise.

### DETAILED DESCRIPTION OF THE INVENTION

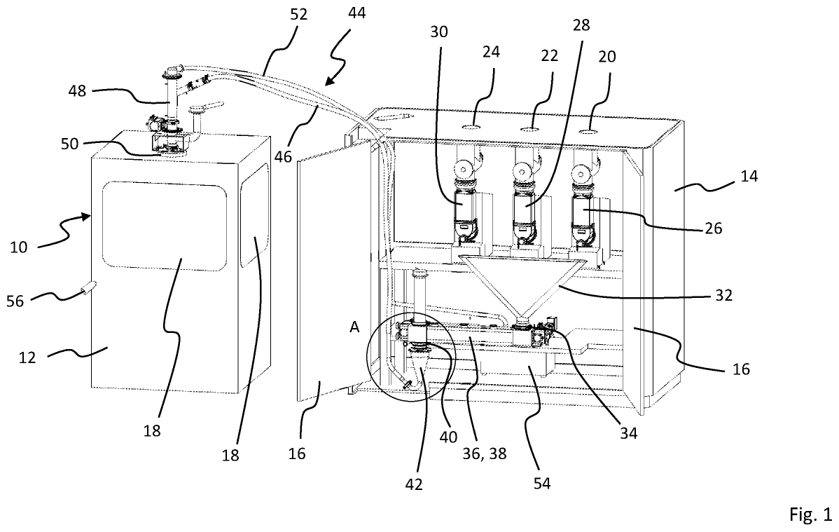

FIG. 1 shows a system for continuously processing pulverulent products, comprising a rotary press 10, presently a rotary tablet press 10. The rotary tablet press 10 is arranged in a housing 12. A module housing 14 is arranged next to the rotary tablet press 10 on the same ground. In FIG. 1, the module housing 14 is shown with the doors 16 opened for purposes of illustration. The housing 12 of the rotary tablet press 10 has windows 18 which can also be opened for access to the rotary tablet press 10.

The module housing 14 has on its upper side three system inlets 20, 22, 24 through which the pulverulent products can be supplied, for example, active pharmaceutical ingredients and/or excipients. Each of the inlets 20, 22, 24 has a metering apparatus 26, 28, 30 through which the supplied pulverulent products are metered. In the example shown, a supply funnel 32, to which the pulverulent products supplied through the inlets 20, 22, 24 and the metering apparatuses 26, 28, 30 are conducted, is located downstream of the inlets 20, 22, 24 with the metering apparatuses 26, 28, 30. The outlet of the supply funnel 32 is connected to a mixer inlet 34 of a mixer 36. In the example shown, the mixer 36 has a horizontal mixer tube 38 in which a mixing apparatus is arranged, for example, a rotatable mixing auger. In the mixer tube 38, the pulverulent products supplied via the supply funnel 32 are mixed to form a product mixture, namely a filling material, which is provided at a mixer outlet 40 of the mixer. The mixer outlet 40 is in connection with an, in the example shown, funnel-shaped conveyor reservoir 42 of a conveyor apparatus 44. The conveyor apparatus 44 also comprises a conveyor hose 46 connected to the outlet of the conveyor reservoir 42, the other end of which is connected via an outlet hopper 48 to a press inlet 50 on the upper side of the housing 12 of the rotary tablet press 10. In the example shown, the conveyor apparatus 44 is a pneumatic vacuum conveyor apparatus 44. Accordingly, the conveyor apparatus 44 has a vacuum hose 52 and a vacuum generating unit 54. The vacuum generating unit 54 generates, via the vacuum hose 52, a vacuum at the outlet of the conveyor hose 46, by means of which the product mixture located in the conveyor reservoir 42 is conveyed through the conveyor hose 46 into the outlet hopper 48 and to the press inlet 50 of the rotary tablet press 10. For this purpose, an outlet valve at the outlet of the conveyor hose 46 opens intermittently and then closes again after the respectively conveyed product amount has been let out. Then, this cycle is repeated so that the product mixture is conveyed intermittently out of the conveyor reservoir 42 from the mixer outlet 40 located at a vertically lower level to the press inlet 50 of the rotary tablet press 10 arranged at a vertically higher level. In the rotary tablet press 10, tablets are produced from the supplied product mixture forming the filling material in a manner explained in more detail below, wherein the tablets are discharged at a press outlet 56 of the rotary tablet press 10, where they can be supplied to further processing, for example, dedusting and/or packaging.

The system shown in FIG. 1 serves to continuously process pulverulent products to form pellets produced in the rotary press 10, in the example shown in particular to form tablets pressed in the rotary tablet press 10. The system can be contained, as explained above.

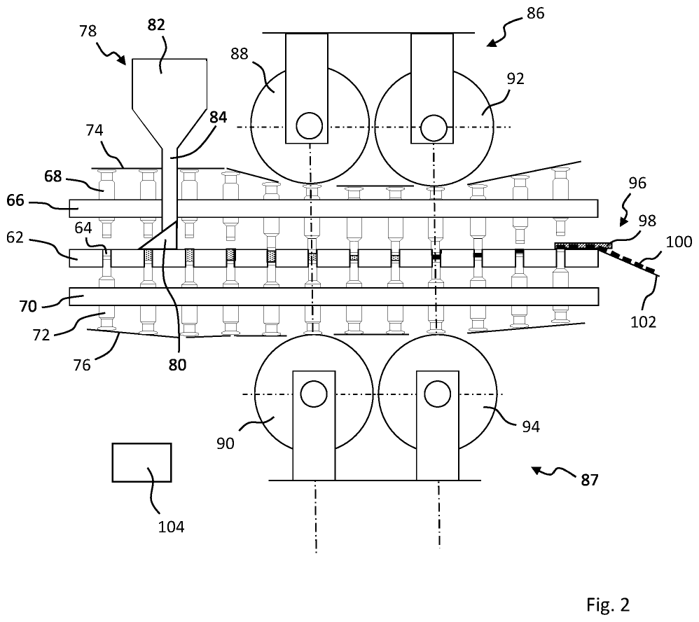

In FIG. 2, a rotary tablet press 10 used, for example, in the system shown in FIG. 1 is shown in an unrolled representation of the rotor. The rotary tablet press shown in FIG. 2 comprises a rotor rotatingly driven by a rotary drive (not shown in detail) with a die plate 62 having a plurality of cavities 64. The cavities 64 can be formed, for example, by bores in the die plate 62. The rotor further comprises a plurality of upper pressing punches 68 guided in an upper punch guide 66 and a plurality of lower pressing punches 72 guided in a lower punch guide 70, which run synchronously with the die plate 62. Each pair of an upper pressing punch 68 and a lower pressing punch 72 is associated with a cavity 64. The axial movement of the upper pressing punches 68 and lower pressing punches 72 in the course of the rotation of the rotor is controlled by upper control curve elements 74 and lower control curve elements 76. The rotary tablet press also comprises a filling apparatus 78 according to the invention. The filling apparatus 78 comprises a funnel-shaped filling material reservoir 82 which is in connection with a filling chamber 80 via a filling tube 84. In this manner, in the present example, the pulverulent filling material enters into the filling chamber 80 through the filling tube 84 due to gravity and out of it again into the cavities 64 of the die plate 62. In addition, the rotary tablet press comprises an upper pressing apparatus 86 and a lower pressing apparatus 87. The upper pressing apparatus 86 has an upper preliminary pressing apparatus with an upper preliminary pressing roller 88 and the lower pressing apparatus comprises a lower preliminary pressing apparatus with a lower preliminary pressing roller 90. The upper pressing apparatus 86 also an upper main pressing apparatus with an upper main pressing roller 92 and the lower pressing apparatus 87 comprises a lower main pressing apparatus with a lower main pressing roller 94. When passing through the pressing apparatuses 86, 87, the upper and lower pressing punches 68, 72 are pushed into the cavities 64 and in the process press the filling material filled into the cavities 64 to form tablets 100. The rotary tablet press further comprises an ejector apparatus 96, in the present case with a stripper 98 which supplies the tablets 100 produced in the rotary press and conveyed by the lower pressing punches 72 and the upper side of the die plate 62 to a tablet discharge 102. A control apparatus 104 controls the operation of the rotary press and is connected inter alia to the rotary drive of the rotor via lines (not shown in detail).

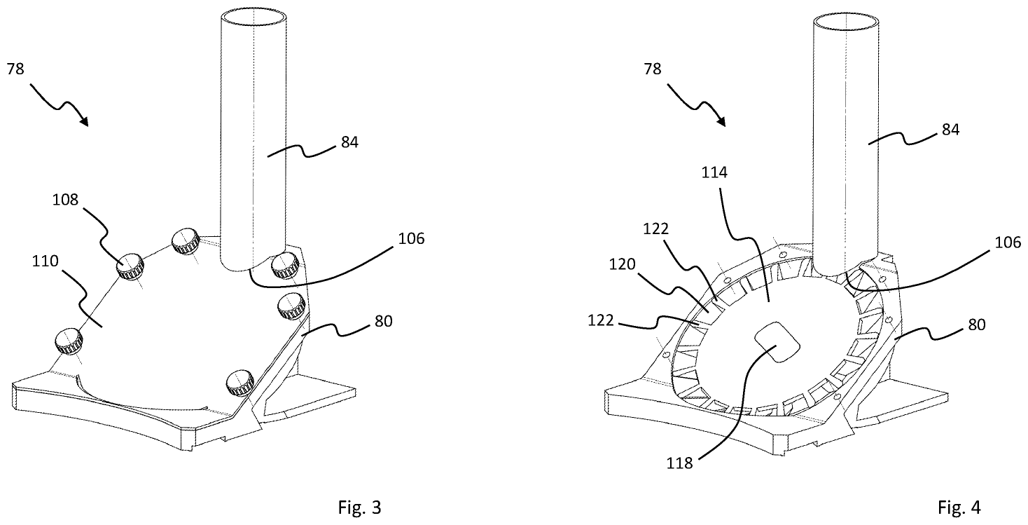

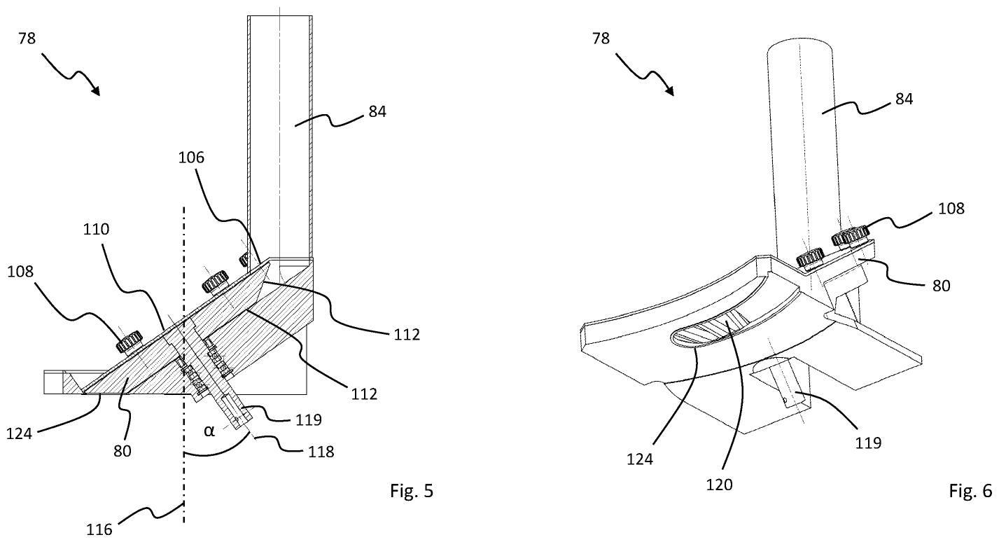

Based on FIGS. 3 to 6, the embodiment of the filling apparatus 78 according to the invention shall be explained in more detail. The lower end of the filling tube 84 forms an inlet opening 106 of the filling chamber 80 through which the filling material enters from the filling tube 84 into the filling chamber 80 due to gravity. The upper side of the filling chamber 80 is closed by a cover 110 fastened by means of screw connections 108. The cover 110 is not shown in FIG. 4 for purposes of illustration. As can be seen in the figures, the filling chamber 80 is arranged at an angle tilted to the horizontal, for example at an angle between 30° and 60°. As can be seen in particular in the section view in FIG. 5, the base 112 of the filling chamber is designed in the shape of a truncated cone. A conveyor wheel 114 is arranged in the filling chamber 80 to be rotatable around a drive shaft 119 about an axis of rotation 118 aligned at an angle α (see FIG. 5) to the vertical 116 by means of a rotary drive (not shown in detail), for example an electric motor. The angle α can be, for example, in a range between 30° and 60°. On its radially outer perimeter, the conveyor wheel 114 has a plurality of conveyor pockets 120 which are arranged along a circular path and each of which are delimited by adjacent side walls 122 and are open on their upper and lower sides. The filling tube 84 is arranged so that filling material falls from the filling tube 84 through the inlet opening 106 into the conveyor pockets 120 of the conveyor wheel 114 rotating below the inlet opening 106 so that the filling material received in the conveyor pockets 120 is further conveyed along the circular path to an outlet opening 124 arranged on the lower side of the filling chamber 80 (see FIG. 6).

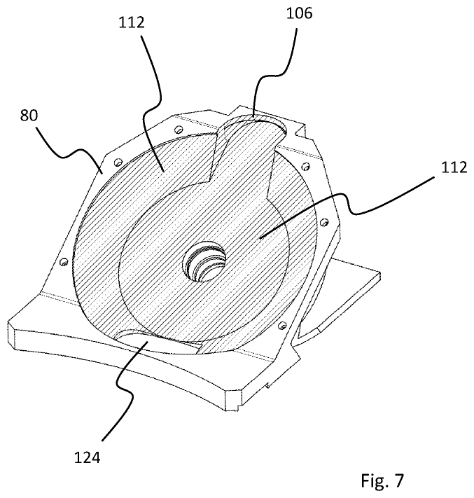

In this manner, the filling material is actively conveyed by the conveyor pockets 120 from the inlet opening 106 to the outlet opening 124. The inlet opening 106 is arranged at a highest position of the conveyor wheel 114 and the outlet opening 124 is arranged at a lowest position of the conveyor wheel 114. As can be seen in particular in FIGS. 4 and 5, the base 112 of the filling chamber 80 is designed tilted in relation to a plane perpendicular to the axis of rotation 118 in the region swept over by the conveyor pockets 120, according to the truncated cone shape explained above. The trough-shaped embodiment of the filling chamber 80 achieved by the truncated cone can be seen particularly well in FIG. 7, in which, in addition to the filling tube 84 and the cover 110, the conveyor wheel 114 is also not shown for purposes of illustration. This reliably prevents product buildup and dead spaces in the conveyor pockets 120. Here, the filling material received in the conveyor pockets 120 is conveyed into the outlet opening 124 and thus into the cavities 64 of the rotary press 10 by centrifugal force in the course of the rotation of the conveyor wheel 114. As can be seen, for example, in FIG. 5, the conveyed path of the filling material from the inlet opening 106 to the outlet opening 124 is such that redirections of the flow direction of the filling material are each smaller than 90°.

A control apparatus, for example the control apparatus 104 of the rotary press 10, can control the rotary drive of the conveyor wheel 114, in particular its rotational speed, and thus the rotational speed of the conveyor wheel 114 in order to control in a suitable manner the amount of filling material supplied to the cavities 64 and/or the filling pressure when filling the cavities 64 with filling material.

### LIST OF REFERENCE SIGNS

10 Rotary tablet press
12 Housing
14 Module housing
16 Doors
18 Windows
20 System inlet
22 System inlet
24 System inlet
26 Metering apparatus
28 Metering apparatus
30 Metering apparatus
32 Supply funnel
34 Mixer inlet
36 Mixer
38 Mixer tube
40 Mixer outlet
42 Conveyor reservoir
44 Conveyor apparatus
46 Conveyor hose
48 Outlet hopper
50 Press inlet
52 Vacuum hose
54 Vacuum generating unit
56 Press outlet
62 Die plate
64 Cavities
66 Upper punch guide
68 Upper pressing punches
70 Lower punch guide
72 Lower pressing punches
74 Upper control curve elements
76 Lower control curve elements
78 Filling apparatus
80 Filling chamber
82 Filling material reservoir
84 Filling tube
86 Upper pressing apparatus
87 Lower pressing apparatus
88 Upper preliminary pressing roller
90 Lower preliminary pressing roller
92 Upper main pressing roller
94 Lower main pressing roller
96 Ejector apparatus
98 Stripper
100 Tablets
102 Tablet discharge
104 Control apparatus
106 Inlet opening
108 Screw connections
110 Cover
112 Base
114 Conveyor wheel
116 Vertical
118 Axis of rotation
119 Drive shaft
120 Conveyor pockets
122 Side walls
124 Outlet opening

1. A filling apparatus configured to fill cavities of a rotary press, comprising:
a filling chamber including an inlet opening through which filling material enters the filling chamber;
an outlet opening through which filling material exits into the cavities of the rotary press; and
a conveyor wheel positioned in the filling chamber and defining a plurality of conveyor pockets structured to receive the filing material, wherein the conveyor wheel is rotatable relative to the filling chamber about an axis of rotation arranged at an angle (α) to a vertical axis,
wherein the plurality of conveyor pockets are arranged along a circular path and are rotated along the inlet opening and along the outlet opening when the conveyor wheel is rotated about the axis of rotation, and
wherein the filling material received in each of the plurality of conveyor pockets is conveyed from the inlet opening to the outlet opening.

2. The filling apparatus according to claim 1, wherein the plurality of conveyor pockets are arranged on a perimeter of the conveyor wheel.

3. The filling apparatus according to claim 2, wherein the plurality of conveyor pockets rotate below the inlet opening and above the outlet opening when the conveyor wheel is rotated about the axis of rotation.

4. The filling apparatus according to claim 1, wherein the inlet opening is positioned at a highest position of the conveyor wheel, and wherein that the outlet opening is positioned at a lowest position of the conveyor wheel.

5. The filling apparatus according to claim 1, wherein the plurality of conveyor pockets each comprise an upper side and a lower side, wherein each of the plurality of conveyor pockets are open on the upper side and the lower side.

6. The filling apparatus according to claim 5, wherein the conveyor wheel comprises a plurality of lateral walls, wherein adjacent lateral walls delimit a conveyor pocket between them.

7. The filling apparatus according to claim 1, wherein an upper side of the comprises a cover, and wherein a distance between the conveyor wheel and the cover is less than 5 mm.

8. The filling apparatus according to claim 7, wherein the distance is not greater than 1 mm.

9. The filling apparatus according to claim 1, wherein the filling chamber further comprises a base, and wherein a distance between the conveyor wheel and the base of the filling chamber is less than 5 mm.

10. The filling apparatus according to claim 1, wherein the filling chamber further comprises a base, wherein the base is tilted at the angle (α) relative to the vertical axis at least in a region swept over by the plurality of conveyor pockets.

11. The filling apparatus according to claim 9, wherein the base of the filling chamber is configured conically at least in a region swept over by the conveyor pockets.

12. The filling apparatus according to claim 10, wherein the base of the filling chamber is configured perpendicular to the axis of rotation.

13. The filling apparatus according to claim 1, wherein the conveyor wheel is configured to convey filling material from the plurality of conveyor pockets into the outlet opening by centrifugal force as the conveyor wheel rotates about the axis of rotation.

14. The filling apparatus according to claim 1, wherein a conveyed path of the filling material from the inlet opening to the outlet opening is such that each redirection of a flow direction of the filling material is smaller than 90°.

15. The filling apparatus according to claim 1, further comprising a control apparatus configured to control an amount of at least one of: (1) the filling material supplied to the cavities; and (ii) a filling pressure when filling the cavities with the filling material.

16. A rotary press comprising:
a rotor configured to rotate and comprising,
an upper punch guide for upper pressing punches, and
a lower punch guide for lower pressing punches;
a die plate defining a plurality of cavities and positioned between the punch guides,
wherein the upper and lower pressing punches interact with plurality of cavities;
at least one upper pressing apparatus;
at least one lower pressing apparatus, wherein the upper and lower pressing apparatus interact during the upper and lower pressing punches;
a filling apparatus comprising,
a filling chamber including an inlet opening through which filling material enters the filling chamber,
an outlet opening through which filling material exits into the cavities of the rotary press, and
a conveyor wheel positioned in the filling chamber and defining a plurality of conveyor pockets structured to receive the filing material, wherein the conveyor wheel is rotatable relative to the filling chamber about an axis of rotation arranged at an angle (α) to a vertical axis; and
an ejector apparatus;
wherein the plurality of conveyor pockets are arranged along a circular path and are rotated along the inlet opening and along the outlet opening when the conveyor wheel is rotated about the axis of rotation,
wherein the filling material received in each of the plurality of conveyor pockets is conveyed from the inlet opening to the outlet opening and filled into the plurality of cavities of the die plate,
wherein the upper and lower pressing punches press the filling material in the plurality of cavities of the die plate to form pellets, and
wherein pellets generated in the cavities are ejected from the rotary press.

17. A system for continuously processing pulverulent products comprising the rotary press of claim 16 including a press inlet, comprising:
at least two system inlets configured to receive pulverulent products; and
a mixer configured to continuously mix the pulverulent products, wherein the mixer comprises at least one mixer inlet connected to the at least two system inlets, and a mixer outlet configured receive filling material mixed in the mixer,
wherein the filling material is conveyed from the mixer outlet to the inlet of the rotary press.
